(19) United States
(12) Patent Application Publication
(10) Pub. No.: US 2020/0148260 A1
(43) Pub. Date: May 14, 2020

(54) LANE CHANGING SYSTEM AND LANE CHANGING METHOD

(71) Applicant: Hua-chuang Automobile Information Technical Center Co., Ltd., New Taipei City (TW)

(72) Inventors: Po-Fu Wu, New Taipei City (TW); Yuan-Chun Chen, New Taipei City (TW); Kang Li, New Taipei City (TW); Cheng-Ming Pan, New Taipei City (TW)

(21) Appl. No.: 16/212,968

(22) Filed: Dec. 7, 2018

(30) Foreign Application Priority Data
Nov. 12, 2018 (CN) 201811340213.3

(51) Int. Cl. B62D 15/02; B62D 6/00; B60W 10/18; B60W 10/20; B60W 30/18

(52) U.S. Cl. CPC B62D 15/0255; B60W 2710/207; B60W 10/18; B60W 10/20; B60W 30/18163; B60W 2520/10; B60W 2520/105; B60W 2520/125; B60W 2520/14; B60W 2520/26; B60W 2510/20; B60W 2520/20; B60W 2520/28; B60W 2530/10; B60W 2510/222; B60W 2550/10; B60W 2550/30; B60W 2550/146; B60W 2710/18; B60W 2710/20; B62D 6/001

(57) ABSTRACT

A lane changing system includes an inertia-detecting unit for detecting a vehicle speed, an acceleration, and body parameters of a vehicle, a geographic information unit for detecting a real-time position of the vehicle and storing road-borderline information, a visual tracker for detecting a road curvature and a relative distance and capturing a road-borderline image and a vehicle-surrounding image, a memory storing vehicle parameters, a processor, and a rotation device. The processor calculates a lateral acceleration according to the vehicle parameters, the vehicle speed, the acceleration, and the road curvature. The processor generates a steering signal when the processor determines that the relative distance is less than a first threshold, the lateral acceleration is less than a second threshold, and there is no other vehicle around the vehicle. The rotation device receives the steering signal to for making the vehicle change from an original vehicle lane to an adjacent vehicle lane.

### CROSS-REFERENCE TO RELATED APPLICATION

This non-provisional application claims priority under 35 U.S.C. § 119(a) to Patent Application No. 201811340213.3 filed in China, P.R.C. on Nov. 12, 2018, the entire contents of which are hereby incorporated by reference.

### BACKGROUND

### Technical Field

The instant disclosure relates to vehicle-driving categories, in particular, to a lane changing system and a lane changing method.

### Related Art

Along with the developments in driverless vehicles or autonomous driving assistant system, vehicles have to be equipped with the troubleshooting ability. For example, when an obstacle is in front of the vehicle or when a car accident is occurred in front of the vehicle, the vehicle needs to have the ability to perform lane changing automatically or to have the ability to assist performing lane changing.

The lane changing method known to the inventor(s) are based on route planning techniques. Most of the route planning techniques have huge and complex computing structures and have to be optimized for better routes. Furthermore, such route planning techniques require a longer time to obtain the routes. As a result, the lane changing method known to the inventor(s) cannot be applied properly in those situations with limited response time.

Furthermore, the lane changing method known to the inventor(s) simply considers the route planning and does not consider the passengers or the goods in the vehicle. It is understood that if the lane changing cannot be performed in a comfortable and safe manner, users may possibly have bad ratings to the driverless vehicles or vehicles with autonomous driving assistant systems.

### SUMMARY

In view of these, in one embodiment, a lane changing system is provided. The lane changing system is installed in the vehicle, and the lane changing system comprises an inertia-detecting unit, a geographic information unit, a visual tracker, a memory, a processor, and a rotation device.

The inertia-detecting unit is configured to detect a vehicle speed, an acceleration, and a plurality of body parameters of the vehicle. The geographic information unit is configured to detect a real-time position of the vehicle and to store road-borderline information. The visual tracker is configured to detect a road curvature and a relative distance and to capture a road-borderline image and a vehicle-surrounding image. The memory is configured to store a plurality of vehicle parameters. The processor is electrically connected to the visual tracker, the geographic information unit, and the inertia-detecting unit.

The processor is configured to receive the vehicle speed, the body parameters, the acceleration, the road curvature, the relative distance, the road-borderline information, the vehicle-surrounding image, and the road-borderline image. The processor is configured to calculate a lateral acceleration according to the vehicle parameters, the vehicle speed, the acceleration, and the road curvature. The processor is configured to generate a steering signal when the processor determines that the relative distance is less than a first threshold and the lateral acceleration is less than a second threshold, and when the processor determines that there is no other vehicle around the vehicle according to the vehicle-surrounding image. The rotation device is electrically connected to the processor. The rotation device is configured to receive the steering signal for making the vehicle from an original vehicle lane change to an adjacent vehicle lane.

In this embodiment, a lane changing method is further provided. The method comprises: detecting a vehicle speed, an acceleration, and a plurality of body parameters of a vehicle by an inertia-detecting unit; detecting a real-time position of the vehicle and storing road-borderline information by a geographic information unit; detecting a road curvature and a relative distance and capturing a road-borderline image and a vehicle-surrounding image by a visual tracker; calculating a lateral acceleration according to a plurality of vehicle parameters stored in a memory, the vehicle speed, the acceleration, and the road curvature by a processor; generating a steering signal by the processor when the processor determines that the relative distance is less than a first threshold and the lateral acceleration is less than a second threshold, and when the processor determines that there is no vehicle around the vehicle according to the vehicle-surrounding image; and receiving the steering signal by a rotation device for making the vehicle from an original vehicle lane change to an adjacent vehicle lane.

Based on one or some embodiments of the instant disclosure, the processor calculates the lateral acceleration of the vehicle to control the lateral acceleration and the lane-changing driving distance when the vehicle performs lane change. Therefore, the passenger can have a comfortable feeling and not getting anxious when the vehicle performs lane change. Similarly, the goods carried by the vehicle can be prevented from being damaged. Consequently, the liability of the driverless vehicles or the autonomous driving assistant system can be improved.

Detailed description of the characteristics and the advantages of the instant disclosure are shown in the following embodiments. The technical content and the implementation of the instant disclosure should be readily apparent to any person skilled in the art from the detailed description, and the purposes and the advantages of the instant disclosure should be readily understood by any person skilled in the art with reference to content, claims, and drawings in the instant disclosure.

### BRIEF DESCRIPTION OF THE DRAWINGS

The disclosure will become more fully understood from the detailed description given herein below for illustration only, and thus not limitative of the disclosure, wherein:

FIG. 1 illustrates a schematic view of a lane changing system according to an exemplary embodiment of the instant disclosure;

FIG. 2 illustrates a flowchart of a lane changing method according to an exemplary embodiment of the instant disclosure; and

FIG. 3 illustrates a top schematic view showing the lane-changing scenario of a vehicle.

### DETAILED DESCRIPTION

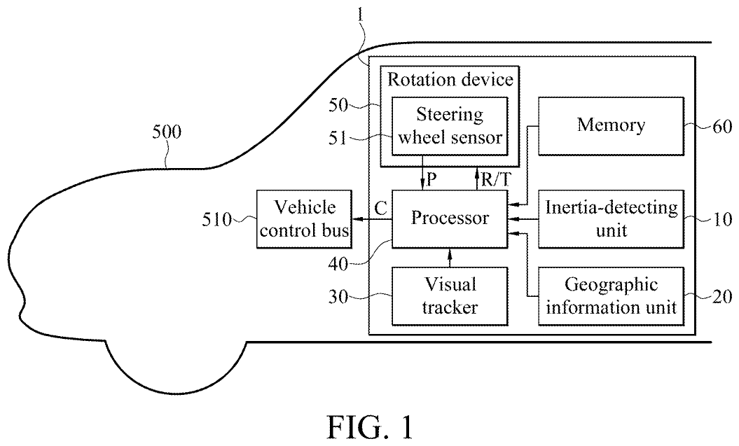

FIG. 1 illustrates a schematic view of a lane changing system according to an exemplary embodiment of the instant disclosure. As shown in FIG. 1, the lane changing system 1 is installed in a vehicle 500. The lane changing system 1 comprises an inertia-detecting unit 10, a geographic information unit 20, a visual tracker 30, a processor 40, a rotation device 50, and a memory 60.

The inertia-detecting unit 10 is an inertial sensor and may comprise an accelerometer, a gyro meter, and a compass. The inertia-detecting unit 10 is configured to detect and output a vehicle speed, an acceleration, and a plurality of body parameters of the vehicle 500. The geographic information unit 20 is configured to detect a real-time position of the vehicle 500 and stores road-borderline information. In detail, the geographic information unit 20 may be a high-precision global positioning system (GPS) unit. The visual tracker 30 is configured to detect and output a road curvature, a relative distance, and the visual tracker 30 is used to capture and output a road-borderline image and a vehicle-surrounding image. The visual tracker 30 comprises a detector, an image-capturing device, and a computing device (not shown). The visual tracker 30 can capture image(s) and can calculate parameters such as the relative distance and the road curvature according to the detector and the image(s).

The memory 60 is configured to store a plurality of vehicle parameters. The memory 60 may comprise any proper volatile or non-volatile computer readable storage media. For example, the memory 60 may comprise a random access memory (RAM), a read-only memory (ROM), a universal serial bus (USB) disk (USB flash drive), a hard disk, a compact disk, a portable storage device, or other storage media or circuits.

The processor 40 may be a central processing unit (CPU), a microprocessor, a control component, or hardware components/computing devices capable of executing instructions. The processor 40 is electrically connected to the visual tracker 30, the geographic information unit 20, the memory 60, and the inertia-detecting unit 10. The processor 40 is configured to receive the vehicle speed, the body parameters, the acceleration, the road curvature, the relative distance, the road-borderline information, the vehicle-surrounding image, and the road-borderline image. Next, the processor 40 calculates a lateral acceleration according to vehicle parameters, the vehicle speed, the acceleration, and the road curvature. Further, the processor 40 generates a steering signal R when the processor 40 determines that the relative distance is less than a first threshold and the lateral acceleration is less than a second threshold, and when the processor 40 determines that there is no vehicle around the vehicle 500 according to the vehicle-surrounding image. The rotation device 50 is electrically connected to the processor 40, and the rotation device 50 is configured to receive the steering signal R for making the vehicle 500 from an original vehicle lane change to an adjacent vehicle lane.

Furthermore, the processor 40 compares the real-time position of the vehicle 500 with the road-borderline information and the road-borderline image to generate a following signal T. The rotation device 50 receives the following signal T to keep the vehicle 500 moving according to the road-borderline information.

Moreover, the condition of “no other vehicles around the vehicle 500 according to the vehicle-surrounding image” is provided as an illustrative example, but not a limitation. The processor 40 can analyze the vehicle-surrounding image to determine if an object with a relative faster speed comes toward the vehicle 500 from the left side, the right side, the rear side, the left-rear side, or the right-rear side. If no object comes toward the vehicle 500 or if the object has a relative slower speed, the processor 40 determines that there is no other vehicle around the vehicle 500. Otherwise, the processor 40 determines that there are other vehicle(s) around the vehicle 500.

In further detail, the vehicle parameter stored in the memory 60 comprises a vehicle mass, a front tire steering rigidity, a rear tire steering rigidity, a distance between a center of gravity of the vehicle 500 and a front tire of the vehicle 500, and a distance between the center of gravity of the vehicle 500 and a rear tire of the vehicle 500. Further, the body parameter detected by the inertia-detecting unit 10 comprise a vehicle yaw rate, a front tire sideslip angle, a rear tire sideslip angle, a front tire speed angel, a rear tire speed angle, and a front tire steering angle. In this embodiment, the front tire sideslip angle may be calculated from equations 1 and 2, the rear tire sideslip angle may be calculated from equations 3 and 4, and the lateral acceleration may be calculated from equations 5 to 7.

α_{f}=δ_{f}−θ_{vf}, Equation 1:

wherein α_{f} is the front tire sideslip angle, δ_{f} is the front steering angle, and θ_{Vf} is the front tire speed angle.

$$θ {v}_{f} = \frac{{V}_{y} + {l}_{f} ψ}{{V}_{x}} , \qquad Equation 2$$

wherein θv_{f} is the front tire speed angle, Vₓ is the linear speed, V_{y} is the lateral speed, l_{f} is a distance between the center of gravity of the vehicle and the front tire of the vehicle, and \dot{ψ} is the vehicle yaw rate.

αᵣ=−θ_{Vr}, Equation 3:

wherein αᵣ is the rear tire sideslip angle, and θ_{Vr} is the front tire speed angle.

$$θ {v}_{r} = \frac{{V}_{y} - {l}_{r} ψ}{{V}_{x}} , \qquad Equation 4$$

wherein θvᵣ is the rear tire angle speed, Vₓ is the linear speed, V_{y} is the lateral speed, lᵣ is a distance between the center of gravity of the vehicle and the rear tire of the vehicle, and ψ is the vehicle yaw rate.

$$LG = \frac{{F}_{yf} + {F}_{yr}}{m} , \qquad Equation 5$$

wherein LG is the lateral acceleration, m is the vehicle mass, F_{yf} is the front tire lateral force, and F_{yr} is the rear tire lateral force.

F_{yf}=C_{f}α_{f}, Equation 6:

wherein F_{yf} is the front tire lateral force, C_{f} is the front tire steering rigidity, and α_{f} is the front tire sideslip angle.

F_{yr}=Cᵣαᵣ, Equation 7:

wherein F_{yr} is the rear tire lateral force, Cᵣ is the rear tire steering rigidity, and α is the rear tire sideslip angle.

Furthermore, the processor 40 can set the second threshold to be in the range from 0.2 G to 0.3 G, and G represents the acceleration of gravity. Therefore, the passenger in the vehicle 500 can have a better feeling and does not feel dizzy when the vehicle 500 performs lane changing. Moreover, the processor 40 can adjust and control the time of that the vehicle 500 from the original lane changes to the adjacent lane is in a range from 1.5 seconds to 4 seconds according to the vehicle speed.

Furthermore, the processor 40 is further electrically connected to a vehicle control bus 510 of the vehicle 500. When the processor 40 determines that the relative distance is less than the first threshold and the lateral acceleration is greater than second threshold, the processor 40 sends a control signal C to the vehicle control bus 510 to adjust the vehicle speed and the acceleration. For example, the processor 40 may adjust the vehicle speed and the acceleration by applying the vehicle brake or reducing the vehicle speed and the acceleration to prevent the vehicle 500 from impacting the obstacle in front of the vehicle 500. Alternatively, when the processor 40 determines that the relative distance is less than the first threshold and the lateral acceleration is less than the second threshold, and when the processor 40 determines that there are other vehicles around the vehicle 500 according to the vehicle-surrounding image, the processor 40 sends a control signal C to the vehicle control bus 510 to adjust the vehicle speed and the acceleration.

Please refer to FIG. 1 again. Furthermore, the rotation device 50 comprises a steering wheel sensor 51. The steering wheel sensor 51 is electrically connected to the processor 40, the steering wheel sensor 51 detects a rotation angle of a steering wheel of the vehicle 500 to generate an angle information P, and the steering wheel sensor 51 sends the angle information P to the processor 40. The processor 40 adjusts the steering signal R according to the angle information P. Therefore, the processor 40 can fine-tune the rotation angle of the steering wheel instantly to prevent from deviations. Furthermore, the angle detected by the steering wheel sensor 51 should be consistent with the road-borderline information stored in the geographic information unit 20 and the road-borderline image captured in the visual tracker 30 when the vehicle 500 complies with the road-borderline information.

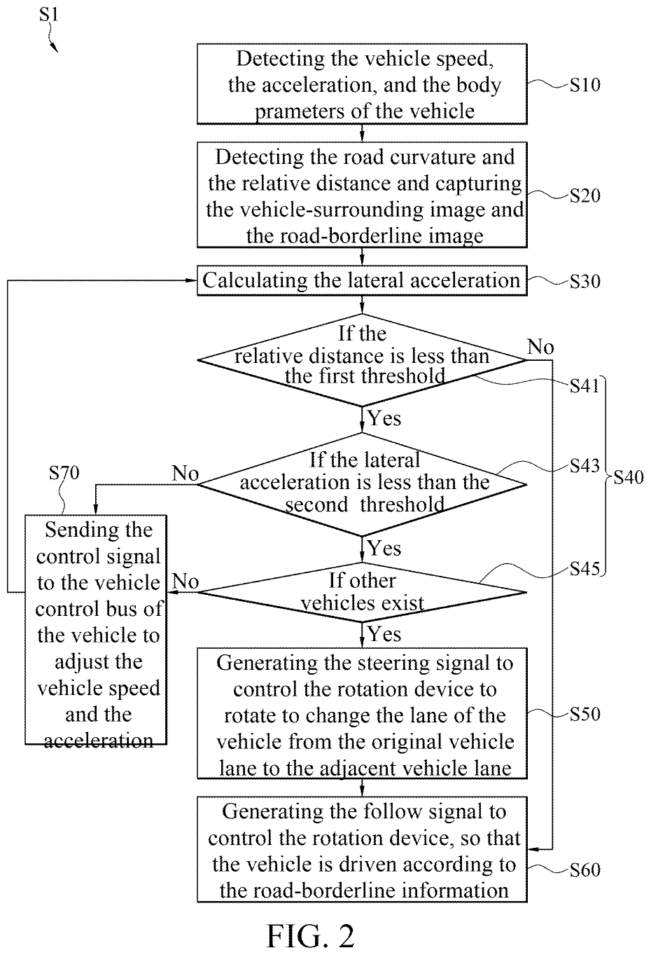

FIG. 2 illustrates a flowchart of a lane changing method according to an exemplary embodiment of the instant disclosure. As shown in FIG. 2, the lane changing method comprises steps S10, S20, S30, S40, S50, S60, and S70. Please refer to FIG. 1. In the step S10, the vehicle speed, the acceleration, and the body parameters of the vehicle 500 are detected by the inertia-detecting unit 10. In the step S20, the road curvature and the relative distance are detected by the visual tracker 30, and the vehicle-surrounding image and the road-borderline image are captured by the visual tracker 30. In the step S30, the lateral acceleration is calculated by the processor 40 according to the vehicle parameters stored in the memory 60, the vehicle speed, the acceleration, and the road curvature, and the calculation is similar to the foregoing paragraphs.

The step S40 is a step having several consecutive determinations, and the step S40 includes steps S41, S43, and S45. In the step S41, the processor 40 determines whether the relative distance is less than the first threshold. If “yes”, the step S43 applies for the further determination(s); if “no”, the step S60 applies. In the step S43, the processor 40 determines whether the lateral acceleration is less than the second threshold. If “yes”, the step S45 applies for the further determination; if “no”, the step S70 applies. In the step S45, the processor 40 determines that if there are other vehicles around the vehicle 500 according to the vehicle-surrounding image. For example, the processor 40 determines if an object or a vehicle comes toward the vehicle 500 from the left side, the right side, the rear side, the left-rear side, or the right-rear side. If “yes”, the step S50 applies; if “no”, the step S70 applies.

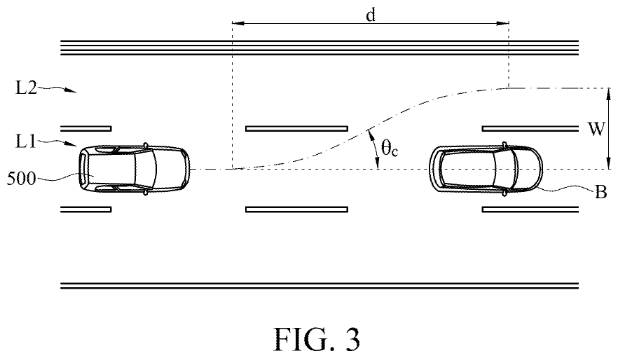

FIG. 3 illustrates a top schematic view showing the lane-changing scenario of the vehicle. Please refer to FIGS. 2 and 3, in the step S50, the steering signal R is generated by the processor 40 to control the rotation device 50 to rotate to change the lane of the vehicle 500 from an original vehicle lane L1 to an adjacent vehicle lane L2. The processor 40 receives the real-time position of the vehicle 500 from the geographic information unit 20 at any time and compares the real-time position of the vehicle 500 with the road-borderline information and the road-borderline image from the geographic information unit 20. When the processor 40 determines that the real-time position of the vehicle 500 is at an adjacent vehicle lane L2, the step S60 applies, and the processor 40 generates a follow signal T to control the rotation device 50, so that the vehicle 500 is driven according to the road-borderline information.

Please refer to FIGS. 1 and 3, if the processor 40 determines the relative distance between the vehicle 500 and the object B in front of the vehicle 500 (e.g., an obstacle in front of the vehicle 500) is greater than the first threshold, the step S60 applies and the processor 40 continues generating the follow signal T to control the rotation device 50, so that the vehicle 500 is driven according to the road-borderline information. In other words, the step S50 is not applied to perform the lane changing of the vehicle 500 unless the situation in front of the vehicle 500 will affect the driving safety of the vehicle 500.

However, when the result of the step S43 is “no”, that is, when the processor 40 determines that the relative distance is less than the first threshold (namely, the relative distance is too short to allow the vehicle 500 to perform lane-changing), and when the processor 40 determines that the lateral acceleration is greater than the second threshold, the step S70 applies, and the processor 40 sends a control signal C to the vehicle control bus 510 of the vehicle 500 to adjust the vehicle speed and the acceleration. Similarly, when the results of the step S41 and S43 are “no” but the result of the step S45 is “yes”, that is, when the processor 40 determines that there are other vehicles around the vehicle 500 according to the vehicle-surrounding image (namely, when the processor 40 determines that the vehicle 500 cannot prevent from impacting one or more vehicles), the step S70 applies, and the processor 40 sends a control signal C to the vehicle control bus 510 of the vehicle 500 to adjust the vehicle speed and the acceleration. In other words, by applying the vehicle brake or reducing the vehicle speed, the vehicle 500 can prevent from impacting the object B in front of the vehicle 500. Furthermore, after the vehicle speed or the acceleration is reduced, the method can go back to the step S30 to perform the calculation again and to have subsequent determination(s). However, it is understood that the order of the steps of the foregoing embodiment(s) is provided as illustrative purposes, but not a limitation. For example, the order of the step S43 and the step S45 can be exchanged.

Further, in the step S60, the rotation device 50 comprises a steering wheel sensor 51 electrically connected to the processor 40. The steering wheel sensor 51 detects the rotation angle of the steering wheel to generate the angle information P and sends the angle information P to the processor 40, and the processor 40 adjusts the steering signal R according to the angle information P.

Please refer to FIG. 3, according to the foregoing calculations, the processor 40 can set the second threshold of the vehicle 500 to be in the range from 0.2 G to 0.3 G, and can adjust and control the time of that the vehicle 500 from the original vehicle lane L1 changes to the adjacent vehicle lane L2 is in a range from 1.5 seconds to 4 seconds. Therefore, a lane-changing driving distance d and a lateral displacement W can be calculated for calculating a yaw angle θ_{c}.

In this embodiment, the relationship between the trace of the yaw angle θ_{c} and the lateral displacement W of the vehicle 500 can be performed by Laplace transform and can be described in equation 8 below by second order damping response format, but embodiments are not limited thereto.

$$\frac{{θ}_{c}}{W} = \frac{{( {w}_{n} )}^{2}}{{Vx}^{*} s ( {s}^{2} + 2 s ( {w}_{n} ) + {( {w}_{n} )}^{2} )} , \qquad Equation 8$$

wherein Vx is the linear speed, θ_{c} is the yaw angle, W is the lateral displacement, wₙ is the system frequency constant, and s is the output variation of the Laplace transform.

Furthermore, the operation function of the rotation device 50 can be described in equation 9 below. Here, the system frequency constant is defined as 6π, the damping ratio is defined as 0.8, but embodiments are not limited thereto.

$$\frac{{δ}_{f}}{{θ}_{c}} = \frac{{( 6 π )}^{2}}{( {s}^{2} + {2}^{*} {0.08}^{*} s ( 6 π ) + {( 6 π )}^{2} )} , \qquad Equation 9$$

wherein θ_{c} is the yaw angle, δ_{f} is the front steering angle, and s is the output variation of the Laplace transform.

Moreover, the space-state of the vehicle 500 can be described by equations 10 and 11.

$$\frac{d}{dt} X = AX + B {δ}_{f} , \qquad Equation 10$$

wherein X is the state-space variable, δ_{f} is the front steering angle, and A and B are system constants of the vehicle 500.

output=CX, Equation 11:

wherein C is another system constant, and X is the state-space variable. Accordingly, equations 10 and 11 describe a system with several inputs (δ_{f}) several outputs, and several state-space variables X, and the derivatives of the state-space variables are represented as linear combinations of all of the space-state variables and the inputs.

Equation 12 is the expansion of equations 10 and 11, and equation 12 is processed with Laplace transform to obtain equation 13. Accordingly, \dot{y} and \dot{ψ} can be calculated for the connection with the foregoing equations 1 to 7.

$$Equation 12$$

$$\frac{d}{dt} [ \begin{matrix}\dot{y} \\ \dot{ψ}\end{matrix} ] = [ \begin{matrix}\frac{- 2 ( {C}_{f} + {C}_{r} )}{{mV}_{x}} & - {V}_{x} + \frac{2 ( {C}_{r} {l}_{r} - {C}_{f} {l}_{f} )}{{mV}_{x}} \\ \frac{2 ( {C}_{r} {l}_{r} - {C}_{f} {l}_{f} )}{{IV}_{x}} & \frac{- 2 ( {C}_{r} {l}_{r}^{2} - {C}_{f} {l}_{f}^{2} )}{{IV}_{x}}\end{matrix} ] [ \begin{matrix}\dot{y} \\ \dot{ψ}\end{matrix} ] + [ \begin{matrix}\frac{2 {C}_{f}}{m} \\ \frac{2 {l}_{f} {C}_{f}}{I}\end{matrix} ] {δ}_{f} , \\ output = [ \begin{matrix}1 & 1\end{matrix} ] [ \begin{matrix}\dot{y} \\ \dot{ψ}\end{matrix} ]$$

$$Equation 13$$

$$\frac{output}{{δ}_{f}} = {C ( SI - A )}^{- 1} B ,$$

wherein C_{f} is the front tire steering rigidity, cᵣ is the rear tire steering rigidity, I is the moment of inertia, l_{f} is a distance between the center of gravity of the vehicle and the front tire of the vehicle, lᵣ is a distance between the center of gravity of the vehicle and the rear tire of the vehicle, m is the vehicle mass, \dot{y} is the lateral speed (that is, V_{y} shown in equations 2 and 4), and ψ is the vehicle yaw rate.

The lane changing method S1 illustrated in FIG. 2 is an implementation, and can be accomplished by a computer program product comprising a plurality of instructions.

The computer program product may be files transmittable on the Internet, or may be stored in a non-transitory computer readable storage medium. When the instructions in the computer program product is loaded by an electric computing device (e.g., the lane changing system illustrated in FIG. 1), the computer program product executes the lane changing method as illustrated in FIG. 2. The non-transitory computer readable storage medium may be an electronic product. For example, the non-transitory computer readable storage medium may be a read-only memory (ROM), a flash memory, a soft disk, a hard disk, a compact disk, a flash drive, a tape, an Internet-accessible record document or other storage media.

Based on one or some embodiments of the instant disclosure, the processor 40 calculates the lateral acceleration of the vehicle 500 to control the lateral acceleration and the lane-changing driving distance when the vehicle 500 performs lane change. Therefore, the passenger can have a comfortable feeling and not getting anxious when the vehicle 500 performs lane change. Similarly, the goods carried by the vehicle 500 can be prevented from being damaged. Consequently, the liability of the driverless vehicles or the autonomous driving assistant system can be improved.

While the instant disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A lane changing system installed in a vehicle, wherein the lane changing system comprises:
an inertia-detecting unit configured to detect a vehicle speed, an acceleration, and a plurality of body parameters of the vehicle;
a geographic information unit configured to detect a real-time position of the vehicle and store road-borderline information;
a visual tracker configured to detect a road curvature and a relative distance, and to capture a road-borderline image and a vehicle-surrounding image;
a memory configured to store a plurality of vehicle parameters;
a processor electrically connected to the visual tracker, the geographic information unit, and the inertia-detecting unit, wherein the processor is configured to:
receive the vehicle speed, the body parameters, the acceleration, the road curvature, the relative distance, the road-borderline information, the vehicle-surrounding image, and the road-borderline image;
calculate a lateral acceleration according to the vehicle parameters, the vehicle speed, the acceleration, and the road curvature; and
generate a steering signal when the processor determines that the relative distance is less than a first threshold and the lateral acceleration is less than a second threshold, and when the processor determines that there is no other vehicle around the vehicle according to the vehicle-surrounding image; and
a rotation device electrically connected to the processor, wherein the rotation device is configured to receive the steering signal for making the vehicle from an original vehicle lane change to an adjacent vehicle lane.

2. The lane changing system according to claim 1, further comprising:
the processor comparing the real-time position of the vehicle with the road-borderline information and the road-borderline image to generate a following signal; and
the rotation device receiving the following signal to keep the vehicle moving according to the road-borderline information.

3. The lane changing system according to claim 1, wherein the processor is further electrically connected to a vehicle control bus of the vehicle, when the processor determines that the relative distance is less than the first threshold and the lateral acceleration is greater than the second threshold, the processor sends a control signal to the vehicle control bus to adjust the vehicle speed and the acceleration.

4. The lane changing system according to claim 1, wherein the processor is further electrically connected to a vehicle control bus of the vehicle, when the processor determines that the relative distance is less than the first threshold and the lateral acceleration is less than the second threshold, and when the processor determines that there are other vehicles around the vehicle according to the vehicle-surrounding image, the processor sends a control signal to the vehicle control bus to adjust the vehicle speed and the acceleration.

5. The lane changing system according to claim 1, wherein the rotation device comprises a steering wheel sensor electrically connected to the processor, the steering wheel sensor detects a rotation angle of a steering wheel of the vehicle to generate an angle information, the steering wheel sensor sends the angle information to the processor, and the processor adjusts the steering signal according to the angle information.

6. The lane changing system according to claim 1, wherein the vehicle parameters comprise a vehicle mass, a front tire steering rigidity, a rear tire steering rigidity, a distance between a center of gravity of the vehicle and a front tire of the vehicle, and a distance between the center of gravity of the vehicle and a rear tire of the vehicle.

7. The lane changing system according to claim 1, wherein the second threshold is in a range from 0.2 G to 0.3 G, and G represents acceleration of gravity.

8. The lane changing system according to claim 7, wherein a time of that the vehicle from the original vehicle lane changes to the adjacent vehicle lane is in a range from 1.5 seconds to 4 seconds.

9. The lane changing system according to claim 1, wherein the body parameters comprise a vehicle yaw rate, a front tire sideslip angle, a rear tire sideslip angle, a front tire speed angle, a rear tire speed angle, and a front tire steering angle.

10. A lane changing method, comprising:
detecting a vehicle speed, an acceleration, and a plurality of body parameters of a vehicle by an inertia-detecting unit;
detecting a real-time position of the vehicle and storing road-borderline information by a geographic information unit;
detecting a road curvature and a relative distance, and capturing a road-borderline image and a vehicle-surrounding image by a visual tracker;
calculating a lateral acceleration according to a plurality of vehicle parameters stored in a memory, the vehicle speed, the acceleration, and the road curvature by a processor;
generating a steering signal by the processor when the processor determines that the relative distance is less than a first threshold and the lateral acceleration is less than a second threshold, and when the processor determines that there is no other vehicle around the vehicle according to the vehicle-surrounding image; and
receiving the steering signal by a rotation device for making the vehicle from an original vehicle lane change to an adjacent vehicle lane.

11. The lane changing method according to claim 10, further comprising:
comparing the real-time position of the vehicle with the road-borderline information and the road-borderline image to generate a following signal by the processor; and
receiving the following signal by the rotation device to keep the vehicle moving according to the road-borderline information.

12. The lane changing method according to claim 10, further comprising:
sending a control signal to a vehicle control bus of the vehicle by the processor to adjust the vehicle speed and the acceleration when the processor determines that the relative distance is less than the first threshold and the lateral acceleration is greater than the second threshold.

13. The lane changing method according to claim 10, further comprising:
sending a control signal to a vehicle control bus of the vehicle by the processor to adjust the vehicle speed and the acceleration when the processor determines that the relative distance is less than the first threshold and the lateral acceleration is less than the second threshold, and when the processor determines that there are other vehicles around the vehicle according to the vehicle-surrounding image.

14. The lane changing method according to claim 10, wherein the rotation device comprises a steering wheel sensor electrically connected to the processor, the steering wheel sensor detects a rotation angle of a steering wheel of the vehicle to generate an angle information, the steering wheel sensor sends the angle information to the processor, and the processor adjusts the steering signal according to the angle information.

15. The lane changing method according to claim 10, wherein the vehicle parameters comprise a vehicle mass, a front tire steering rigidity, a rear tire steering rigidity, a distance between a center of gravity of the vehicle and a front tire of the vehicle, and a distance between the center of gravity of the vehicle and a rear tire of the vehicle.

16. The lane changing method according to claim 10, wherein the second threshold is in a range from 0.2 G to 0.3 G, and G represents acceleration of gravity.

17. The lane changing method according to claim 16, wherein a time of that the vehicle from the original vehicle lane changes to the adjacent vehicle lane is in a range from 1.5 seconds to 4 seconds.

18. The lane changing method according to claim 10, wherein the body parameters comprise a vehicle yaw rate, a front tire sideslip angle, a rear tire sideslip angle, a front tire speed angle, a rear tire speed angle, and a front tire steering angle.
